(19) United States
(12) Patent Application Publication
(10) Pub. No.: US 2002/0001553 A1
(43) Pub. Date: Jan. 3, 2002

(54) Process for removing arsenic compounds from hydrogen fluoride

(76) Inventors: Andreas Bulan, Langenfeld (DE); Gunter Lailach, Krefeld (DE)

Correspondence Address: BAYER CORPORATION, PATENT DEPARTMENT, 100 BAYER ROAD, PITTSBURGH, PA, 15205, US

(21) Appl. No.: 09/891,780

(22) Filed: Jun. 26, 2001

(30) Foreign Application Priority Data
Jun. 28, 2000 (DE) 10031566.6

(51) Int. Cl. C01B 7/07; B01D 53/38

(52) U.S. Cl. 423/210; 423/488

(57) ABSTRACT

The invention relates to a novel process for removing arsenic compounds from the distillation bottoms from hydrogen fluoride distillation in which the distillation bottoms are first concentrated by evaporation of hydrogen fluoride until the temperature at the bottom is from 40 to 60° C., and the residue is then reacted with calcium hydroxide, calcium oxide, or a mixture thereof to give, in a simple manner, a product capable of disposal in a landfill.

### BACKGROUND OF THE INVENTION

The invention relates to a process for removing arsenic compounds from the distillation bottoms from the purification of hydrogen fluoride by distillation.

The purification of hydrogen fluoride is usually carried out in such a way that the arsenic in oxidation state (III) that is present in the hydrogen fluoride is oxidized by means of an oxidant. This converts the arsenic into a relatively nonvolatile arsenic(V) compound from which the hydrogen fluoride can be separated by distillation.

Many compounds are suitable as oxidants for this purpose. Examples are elemental fluorine (cf. U.S. Pat. No. 4,668,497), oxygen difluoride (cf. EP-A 610 748), or electrochemical oxidation (cf. JP 46-15768). The distillation carried out after the oxidation gives low-arsenic hydrogen fluoride as product taken off at the top and arsenic-rich bottoms as bottom product.

The removal of arsenic from the distillation bottoms can, according to the prior art (cf. EP-A 660 803), be carried out by subjecting them to a further distillation after oxidation of the bottoms that have a water content of from 75 to 95% by weight. The bottoms that then remain are brought to a pH of greater than 10 by addition of particular alkali metal and alkaline earth metal compounds, simultaneously forming calcium or magnesium hexafluoroarsenates. Subsequent heating hydrolyses the hexafluoroarsenates and forms the corresponding arsenates. These arsenates are sparingly soluble.

Another possible way of removing arsenic is, according to U.S. Pat. No. 5,089,241, to carry out direct hydrolysis of the hexafluoroarsenic acid present. For this purpose, the aqueous solution containing hexafluoroarsenic acid is treated with sulfuric acid, arsenic acid, perchloric acid, or mixtures thereof to catalyze the hydrolysis to arsenic acid. Hydrogen fluoride is subsequently distilled from this mixture.

A disadvantage of the known processes is that a great outlay is required for the hydrolysis of the hexafluoroarsenate ion. Despite this outlay, the arsenate-containing residue obtained as described in EP-A 660 803 has to be deposited in a landfill for hazardous waste.

It is therefore an object of the present invention to separate off arsenic compounds capable of disposal in a landfill in the preparation of pure hydrogen fluoride in such a way that the separation can be carried out in a simple manner and the amount of material to be deposited in a landfill is as small as possible.

It has been found that the distillation bottoms obtained in the purification of hydrogen fluoride by distillation can be converted directly into a product capable of disposal in a landfill by reaction with calcium hydroxide, calcium oxide, or a mixture thereof.

### SUMMARY OF THE INVENTION

The present invention accordingly provides a process for removing arsenic compounds from the distillation bottoms obtained in the distillation of arsenic-containing hydrogen fluoride comprising

(a) concentrating the distillation bottoms by evaporation of hydrogen fluoride until the temperature at the bottom is from 40 to 60° C. (preferably from 40 to 50° C.), and

(b) reacting the residue with calcium hydroxide, calcium oxide, or a mixture thereof.

### DETAILED DESCRIPTION OF THE INVENTION

The calcium hydroxide, oxide, or mixture thereof is used in an amount sufficient for stoichiometric conversion of the constituents H₂SO₄ and HAsF₆ present in the residue into CaF₂, CaSO₄, and Ca(AsF₆)₂. An excess of 100% by weight of calcium hydroxide, oxide, or mixture thereof is possible as a maximum. The water content of the bottoms after concentration, when a temperature at the bottom of from 40 to 60° C. has been reached, is preferably less than 20% by weight.

The process of the invention is employed for the work-up of distillation bottoms as are obtained in the purification of commercial hydrogen fluoride by distillation.

Commercial hydrogen fluoride generally has an arsenic content of from 15 to 500 ppm and also a water content of from 200 to 1000 ppm, a sulfuric acid content of from 20 to 500 ppm, and a sulfur dioxide content of from 20 to 200 ppm.

Hydrogen fluoride that is particularly suitable for carrying out the process of the invention contains less than 300 ppm (preferably less than 200 ppm) of water, less than 50 ppm (preferably less than 20 ppm) of sulfuric acid, and less than 50 ppm (preferably less than 20 ppm) of sulfur dioxide and has an arsenic content of from 30 to 500 ppm.

To convert arsenic in the oxidation state (III) into arsenic in the oxidation state (V), the hydrogen fluoride is treated with an oxidant. For carrying out the process of the invention, the arsenic(III) is preferably oxidized by means of fluorine, oxygen difluoride, or electrochemically.

The hydrogen fluoride that has been treated in this way is distilled. Here, a hydrogen fluoride containing less than 100 ppm of water, less than 10 ppm of sulfuric acid, and less than 1 ppm of arsenic is obtained as product taken off at the top. The distillation is usually carried out in a distillation column made of steel (preferably carbon steel) at a temperature at the bottom of not more than 30° C. (preferably not more than 26° C.), with a bottom product having a hydrogen fluoride content of at least 98% by weight and an arsenic content of 500 to 2000 ppm being taken off.

The distillation is usually carried out at a pressure of from 0.6 to 2 bar, preferably 0.9 to 1.1 bar.

The bottom product that is taken off is fed to an evaporator that is protected against corrosion by a plastic lining. The hydrogen fluoride vapors from the evaporator can be condensed, but are preferably recirculated to the distillation column.

The liquid residue from the evaporator is reacted with calcium hydroxide, calcium oxide, or a mixture thereof. The reaction can be carried out for example, in a mixer or kneader. The reaction products calcium fluoride, calcium sulfate, calcium sulfate dihydrate, and calcium hexafluoroarsenate are deposited in a suitable landfill in dry or moist form.

### EXAMPLE

A stream of 2 t/h of hydrogen fluoride having a water concentration of about 100 ppm, a sulfuric acid concentration of 18 ppm, and an arsenic concentration of 32 ppm was brought into contact with 300 l/h of a mixture of 10% by volume of fluorine in nitrogen in order to oxidize arsenic trifluoride to arsenic pentafluoride, which forms hexafluoroarsenic acid with hydrogen fluoride, and was subsequently fed into a distillation column for the removal of high-boiling compounds. The column was made of carbon steel. 1.9 t/h of highly pure hydrogen fluoride having a water content of less than 100 ppm, a sulfuric acid content of less than 5 ppm, and an arsenic content of less than 0.3 ppm were taken off at the top of the column. The temperature at the bottom of the distillation column was 24° C. The distillation bottoms contained 99.6% by weight of hydrogen fluoride, 0.2% by weight of water, 0.037% by weight of sulfuric acid, and 0.165% by weight of hexafluoroarsenic acid.

A stream of 0.1 t/h was taken from the bottom of the distillation column and fed to an evaporator. The evaporator was operated until the boiling point had risen from 24° C. to 48° C. The hydrogen fluoride leaving the vaporizer was condensed. After a boiling point of 48° C. had been reached, the liquid contents of the evaporator were analyzed. The composition was 64% by weight of hydrogen fluoride, 17.3% by weight of water, 3.4% by weight of sulfuric acid, and 15.3% by weight of hexafluoroarsenic acid. This residue was reacted in a kneader with calcium oxide in a weight ratio of 1:1.5. A crumbly product could be taken from the kneader and deposited in a suitable landfill.

What is claimed is:

1. A process for removing arsenic compounds from the distillation bottoms obtained in the distillation of arsenic-containing hydrogen fluoride comprising
(a) concentrating the distillation bottoms by evaporation of hydrogen fluoride until the temperature at the bottom is from 40 to 60° C., and
(b) reacting the residue with calcium hydroxide, calcium oxide, or a mixture thereof.

2. A process according to claim 1 wherein the water content of the bottoms after concentration is less than 20% by weight.

3. A process according to claim 1 wherein the arsenic-containing hydrogen fluoride contains not more than 300 ppm of water, not more than 50 ppm of sulfuric acid, and not more than 50 ppm of sulfur dioxide.

4. A process according to claim 1 wherein the amount of calcium hydroxide, calcium oxide, or mixture thereof corresponds to the amount necessary for stoichiometric conversion of the bottom products sulfuric acid, hydrofluoric acid, and hexafluoroarsenic acid into the corresponding calcium compounds.
